(19) United States
(12) Patent Application Publication
(10) Pub. No.: US 2015/0211622 A1
(43) Pub. Date: Jul. 30, 2015

(54) GEAR AND METHOD FOR PRODUCING SAME

(71) Applicant: ENPLAS CORPORATION, Saitama (JP)

(72) Inventor: Kenji Ohmi, Saitama (JP)

(21) Appl. No.: 14/429,341

(22) PCT Filed: Sep. 17, 2013
(86) PCT No.: PCT/JP2013/075043

§ 371 Date: Mar. 18, 2015

(30) Foreign Application Priority Data
Sep. 21, 2012 (JP) 2012-207917
Oct. 4, 2012 (JP) 2012-222037
Aug. 29, 2013 (JP) 2013-178160

(51) Int. Cl. F16H 55/08; B23F 5/26

(52) U.S. Cl. CPC F16H 55/0806; B23F 5/26

(57) ABSTRACT

A gear including plural teeth 3 to mesh with teeth of a corresponding gear to thereby transmit a rotational motion is provided. A form (b) of a tooth root side of each tooth 3 includes: a first curved surface c that is smoothly connected to a tooth surface a having an involute curve and has a profile expressed by a curve that is convex in an inverse direction of the involute curve of the tooth surface a; and a second curved surface d that is smoothly connected to the first curved surface c and has a profile defined by a hyperbolic function having a curve being convex in the same direction as the first curved surface c. It is possible to reduce a stress generated on the tooth root side at the time of meshing with teeth of the corresponding gear and thus to increase the strength of the teeth.

### TECHNICAL FIELD

The present invention relates to a gear that includes a plurality of teeth to mesh with teeth of a corresponding gear to thereby transmit a rotational motion between two shafts, and more particularly, relates to a gear having a tooth profile that can reduce a stress generated on a tooth root side at the time of meshing with teeth of a corresponding gear and increase the strength of the teeth and a method for producing the same.

### BACKGROUND ART

Conventionally, numerous attempts have been made to increase the strength of teeth of a gear used in power transmission mechanisms, such as in an automobile, precise machinery, and the like.

As such type of gear includes a ring gear having teeth and tooth spaces, in which the teeth mesh with teeth of a corresponding gear (pinion) working together via tooth flanks, in which the tooth flanks, after a final meshing point of the pinion, from a tooth top to a tooth bottom, compared to standard tooth flanks, are made to approximate a trochoid, described by the pinion and projected into a normal section, the tooth spaces being embodied in cross section in the form of a pointed arch in the region of the tooth bottom (for example, see Patent Document 1).

### REFERENCE DOCUMENT LIST

### Patent Document

Patent Document 1: Published Japanese Translation of PCT Publication for Patent Application No. 2004-519644

### SUMMARY OF THE INVENTION

### Problems to be Solved by the Invention

However, in the gear described in Patent Document 1, since the tooth space between neighboring teeth has a pointed arch shape in the region of the tooth bottom in a transverse cross-sectional view, a pointed triangular depressed point is formed in the tooth bottom. In such a gear, a stress is likely to be concentrated on the depressed point of the tooth bottom at the time of meshing with the teeth of the corresponding gear and the generated stress may increase to damage the gear. Accordingly, there is demand for an increase in strength of the entire gear including the tooth bottom.

Therefore, the invention is made to solve the aforementioned problem and an object of the invention is to provide a gear having a tooth profile that can reduce a stress generated on a tooth root side at the time of meshing with teeth of a corresponding gear and increase the strength of the teeth, and to provide a method for producing the same.

### Means for Solving the Problems

In order to achieve the aforementioned object, according to a first aspect, there is provided a gear including a plurality of teeth to mesh with teeth of a corresponding gear to thereby transmit a rotational motion, in which a form of a tooth root side of each tooth includes: a first curved surface that is smoothly connected to a tooth surface having an involute curve and has a profile expressed by a curve that is convex in an inverse direction of the involute curve of the tooth surface; and a second curved surface that is smoothly connected to the first curved surface and has a profile defined by a hyperbolic function having a curve being convex in the same direction as the first curved surface.

The profile of the second curved surface, when viewed in a tooth perpendicular section thereof, may be a curve with a curvature radius that does not interfere with a locus of motion of the meshing teeth of the corresponding gear.

The profile of the first curved surface, when viewed in a tooth perpendicular section thereof, may be a spline curve that follows along an arc with a curvature radius that does not interfere with a locus of motion of the meshing teeth of the corresponding gear or along an interference region of the locus of motion.

According to a second aspect, there is provided a gear including a plurality of teeth to mesh with teeth of a corresponding gear to thereby transmit a rotational motion, in which a form of a tooth root side of each tooth is identical to a form shaped by gear-generation cutting using a rack-type cutter having a blade edge including a round portion with a curve defined by a hyperbolic function.

According to the second embodiment, there is also provided a method of producing a gear including a plurality of teeth to mesh with teeth of a corresponding gear to thereby transmit a rotational motion, the method including the step of: forming a tooth root side of each tooth to a form identical to a form shaped by gear-generation cutting using a rack-type cutter having a blade edge including a round portion with a curve defined by a hyperbolic function.

In the method of producing a gear, the gear may be made of metal and the tooth root side of each tooth may be subjected to the gear-generation cutting using a rack-type cutter having the blade edge including the round portion of the curve defined by the hyperbolic function.

In the method of producing a gear, the gear may be made of resin and the gear may be injection-molded by using a gear piece formed based on a gear in which a tooth root side of each tooth is subjected to the gear-generation cutting using the rack-type cutter having the blade edge including the round portion of the curve defined by the hyperbolic function.

### Effects of the Invention

In the gear according to the first aspect, the form of the tooth root side of each tooth includes the first curved surface that is smoothly connected to the tooth surface having the involute curve and has the profile expressed by the curve that is convex in the inverse direction of the involute curve of the tooth surface, and the second curved surface that is smoothly connected to the first curved surface and has the profile defined by the hyperbolic function having a curve being convex in the same direction as the first curved surface. Accordingly, it is possible to form a curved surface having a profile defined by a hyperbolic function without forming a pointed triangular depressed point on the tooth bottom surface. Therefore, a stress is hardly concentrated on the tooth root side and it is possible to reduce a stress generated on the tooth root side at the time of meshing with the teeth of the corresponding gear and to increase the strength of the teeth. As a result, it is possible to improve long-term durability characteristics of the teeth.

In the gear according to the second aspect, the form of the tooth root side of each tooth can be identical to the form shaped by the gear-generation cutting using the rack-type cutter having the blade edge including the round portion with the curve defined by the hyperbolic function without forming a pointed triangular depressed point on the tooth bottom surface. Accordingly, a stress is hardly concentrated on the tooth root side and it is possible to reduce a stress generated on the tooth root side at the time of meshing with the teeth of the corresponding gear and to increase the strength of the teeth. As a result, it is possible to improve long-term durability characteristics of the teeth.

In the method of producing a gear according to the second aspect, the form of the tooth root side of each tooth can be identical to the form shaped by the gear-generation cutting using the rack-type cutter having the blade edge including the round portion with the curve defined by the hyperbolic function, without forming a pointed triangular depressed point on the tooth bottom surface. Accordingly, a stress is hardly concentrated on the tooth root side and it is possible to reduce a stress generated on the tooth root side at the time of meshing with the teeth of the corresponding gear and to increase the strength of the teeth. As a result, it is possible to improve long-term durability characteristics of the teeth.

### BRIEF DESCRIPTION OF THE DRAWINGS

FIG. 1 is a front view illustrating the overall form of a gear according to the invention.

FIG. 2 is a perspective view illustrating a tooth profile of a standard gear.

FIG. 3 is an enlarged explanatory view illustrating a tooth profile of a gear according to a first embodiment.

FIG. 4 is an explanatory view illustrating a locus of motion of a tooth surface on a tooth top side of a corresponding gear which comes in contact with the teeth of the gear according to the first embodiment at the time of meshing with each other.

FIG. 5 is an explanatory view illustrating a detailed profile of A-portion of FIG. 4.

FIG. 6 is a graph illustrating a stress distribution as an analysis result of simulation of a first comparative gear.

FIG. 7 is a graph illustrating a stress distribution as an analysis result of simulation of the gear according to the first embodiment.

FIG. 8 is a table illustrating durability test results of the gear according to the first embodiment and the first comparative gear.

FIG. 9 is an enlarged explanatory view illustrating a tooth profile of a modified gear according to the first embodiment.

FIG. 10 is a table illustrating durability test results of the modified gear according to the first embodiment and the first comparative gear.

FIG. 11 is an enlarged explanatory view illustrating a tooth profile of a gear according to a second embodiment.

FIG. 12 is an explanatory view illustrating a rack-type cutter having a blade edge including a round portion with a curve defined by a hyperbolic function.

FIG. 13 is an explanatory view illustrating a detailed profile of B-portion of FIG. 12.

FIG. 14 is an explanatory view illustrating a locus of motion of the blade edge at the time of performing gear-generation cutting using the rack-type cutter illustrated in FIG. 12.

FIG. 15 is a graph illustrating a stress distribution as an analysis result of simulation of a second comparative gear.

FIG. 16 is a graph illustrating a stress distribution as an analysis result of simulation of the gear according to the second embodiment.

### REFERENCE SYMBOLS LIST

1 Gear
3 Tooth
6 Tooth top surface
7 Tooth bottom surface
10 Rack-type cutter
11 Blade of rack-type cutter
12 Blade edge of rack-type cutter
a Tooth surface
b Tooth surface on tooth root side
c First curved surface
d Second curved surface
g Arc in conventional example
h Curve defined by hyperbolic function
P Pitch circle
T Trochoid curve
U Curve

### Mode for Carrying Out the Invention

Hereinafter, embodiments of the invention will be described with reference to the accompanying drawings.

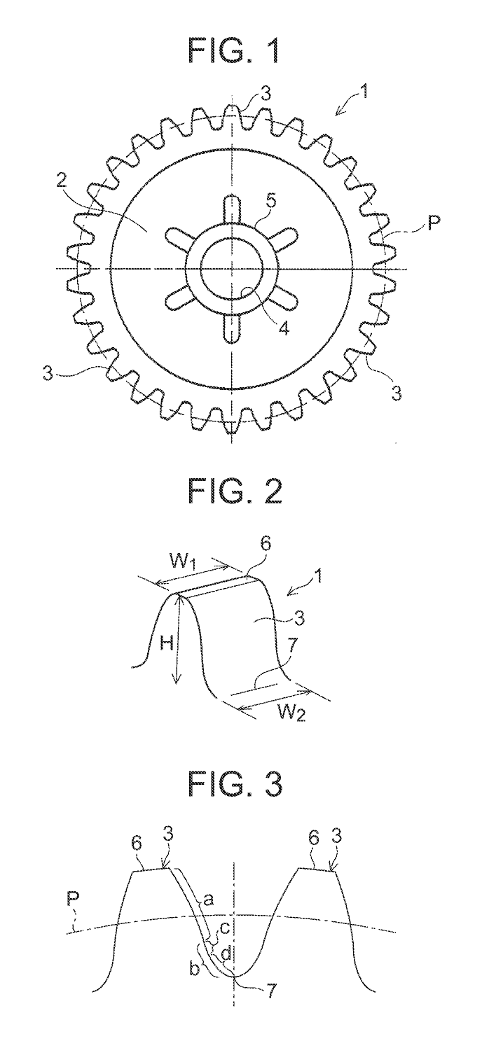

FIG. 1 is a front view illustrating the overall form of a gear according to the invention. This gear includes a plurality of teeth to mesh with teeth of a corresponding gear to thereby transmit a rotational motion between two shafts, and is widely used, for example, for power transmission mechanisms, such as an automobile, a precise machine, an industrial machine, and components thereof.

In FIG. 1, a gear 1 is provided with a plurality of teeth 3, 3, . . . formed on the outer peripheral side of a substantially disk-like web 2, and a boss 5, through which a shaft hole 4 for fixing therein a rotating shaft is bored, at the center of the web 2, so that the gear 1 transmits a rotational motion between two shafts. Reference symbol P denotes a pitch circle of the gear 1.

In general, as illustrated in FIG. 2, each tooth 3 of the gear 1 is formed to have a tooth profile of a standard gear, which includes a tooth surface having an involute curve and is symmetric. That is, in each tooth 3, the tooth width W₁ of a tooth top surface 6 and the tooth width W₂ of a tooth bottom surface 7 (which is the lowest bottom surface in a tooth space between neighboring teeth 3 and 3) have the same size, and the whole depth H is constant in the tooth width direction.

FIG. 3 is an enlarged explanatory view illustrating a tooth profile of the tooth 3 of the gear 1 according to a first embodiment. In FIG. 3, in a side face of the tooth 3, a tooth surface a is provided, and a tooth surface b is provided on the tooth root side with respect to the tooth surface a. The tooth 3 of the gear 1 according to the first embodiment is provided with an advantageous profile of the tooth surface b on the tooth root side, and the tooth surface b on the tooth root side of each tooth 3 includes a first curved surface c and a second curved surface d as illustrated in FIG. 3.

That is, the first curved surface c is a curved surface smoothly connected to the tooth surface a having the involute curve, and has a profile expressed by a curve that is convex in the inverse direction of the involute curve of the tooth surface a.

The second curved surface d is smoothly connected to the first curved surface c, and has a profile defined by a hyperbolic function having a curve being convex in the same direction as the first curved surface c. The hyperbolic function is expressed by y=cos h(x), called a hyperbolic cosine function. Alternatively, the hyperbolic function may be a part of a hyperbolic function, and may be expressed by y=k×cos h(x/k) (where k is a coefficient), called a catenary curve.

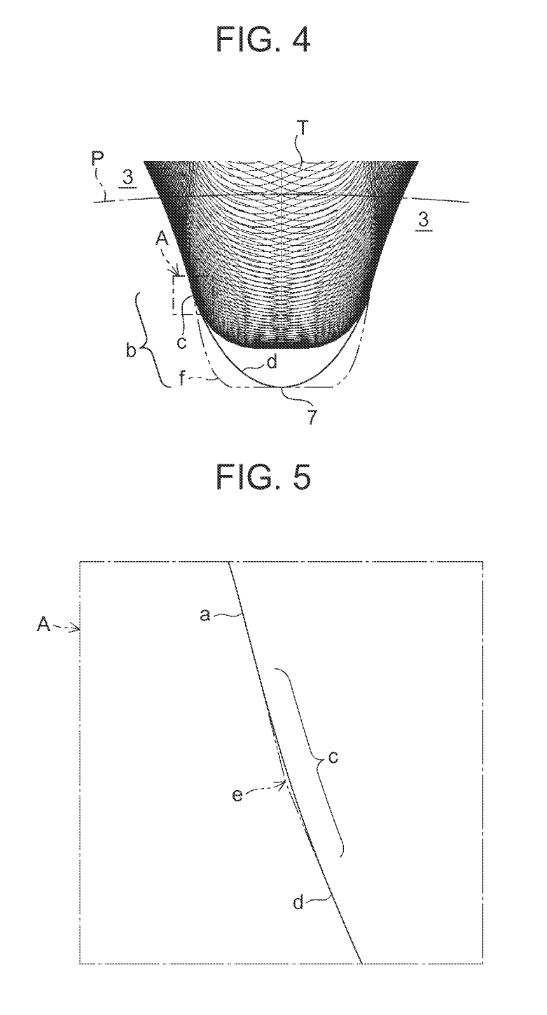

This tooth profile is determined as follows. First, in FIG. 4, when viewed in a cross section of the tooth 3 perpendicular to the tooth surface width direction of the tooth 3 (referred to as a “tooth perpendicular section”), the profile of the second curved surface d is determined to be a curve with a curvature radius that does not interfere with a locus of motion of the meshing teeth of the corresponding gear, and a curve that comes in contact with the tooth bottom surface 7 of the standard gear (see FIG. 2). That is, the locus of motion of the tooth surface on the tooth top side of the corresponding gear (not illustrated) coming in contact with the tooth 3 of the gear at the time of meshing can be a trochoid curve T as illustrated in FIG. 4. The trochoid curve T remains within a region that does not reach the tooth bottom surface 7 in the tooth space between the teeth 3 and 3 of the standard gear. In this state, the profile may be determined to be a curve with the curvature radius which does not interfere with the trochoid curve T, which is the locus of motion of the teeth of the corresponding gear, and to be a curve defined by a hyperbolic function having a curve which is in contact with the tooth bottom surface 7 of the standard gear. In this case, the second curved surface d is formed to have a profile locating inside the tooth surface profile of the tooth root side of the standard gear as indicated by a broken line f in FIG. 4, and thus the tooth thickness on the tooth root side becomes greater than that of the conventional tooth. A pointed triangular depressed point as described in Patent Document 1 is not formed on the tooth bottom surface 7 of the gear. In FIG. 4, the profile of the second curved surface d defined by the hyperbolic function is formed to be the curve which is in contact with the tooth bottom surface 7 of the standard gear, but the present invention is not limited thereto, and the curve of the second curved surface may be set to any position as long as it does not interfere with the locus of motion of the teeth of the corresponding gear. For example, when the curve of the second curved surface is set to a position above the tooth bottom surface 7 of the standard gear, it is possible to further increase the strength of the teeth.

Next, in FIG. 4, the profile of the first curved surface c, when viewed in the tooth perpendicular section of the tooth 3, is set to a spline curve that follows along an arc with a curvature radius that does not interfere with the locus of motion of the meshing teeth of the corresponding gear or along an interference region of the locus of motion. The detailed profile of A-portion of FIG. 4 is illustrated in FIG. 5. In FIG. 5, at a point at which the tooth surface a intersects the curved surface d, there may be an edge e at which the curved profile of the tooth surface a having the involute curve meets the curved profile (curved in the inverse direction of the curved profile of the tooth surface a) of the second curved surface d defined by the hyperbolic function. When such an edge is present on the tooth surface, a stress might be likely to be concentrated thereon. Accordingly, in order to eliminate the edge e, the profile of the first curved surface c can be determined to be the spline curve that follows along the arc with the curvature radius that does not interfere with the trochoid curve T, which is the locus of motion of the teeth of the corresponding gear, or along the interference region of the trochoid curve T, as mentioned above. In this case, the first curved surface c is formed as a smooth tooth surface on which the edge e is not present, that is, the first curved surface c is smoothly connected to the tooth surface a having the involute curve and has the profile expressed by a curve that is convex in the inverse direction of the involute curve of the tooth surface a. Accordingly, it is possible to achieve the tooth profile that does not cause concentration of stress due to the edge.

Regarding the gear 1 according to the first embodiment having the tooth profile determined as described above, results obtained by computer-aided simulating and analyzing (CAE) the stress generated on the tooth root side at the time of meshing will be described below. In this case, a gear with the tooth profile of the standard gear, which is formed by gear-generation cutting using a rack having a blade edge including a round portion defined by an arc is used as a gear to be compared (hereinafter, referred to as “first comparative gear”).

First, calculation models and analysis conditions used for calculating a tooth root stress in the simulation will be described below. The gear according to the first embodiment and the first comparative gear, used in this analysis, were spur gears, in which a module (m) was 1, and the number of teeth was 30. The material thereof was resin (POM), in which a Young's modulus was 2800 MPa, and a Poisson's ratio was about 0.38. The meshing corresponding gear had the same specifications as the gear according to the first embodiment and the first comparative gear. Regarding a load condition, a load of 10 N was applied to the worst loading point position in a direction of a normal line of the tooth surface. A shell mesh model in which only one tooth was extracted was used as the analysis model. “Solid Works” was used as the calculation software for calculating the tooth root stress.

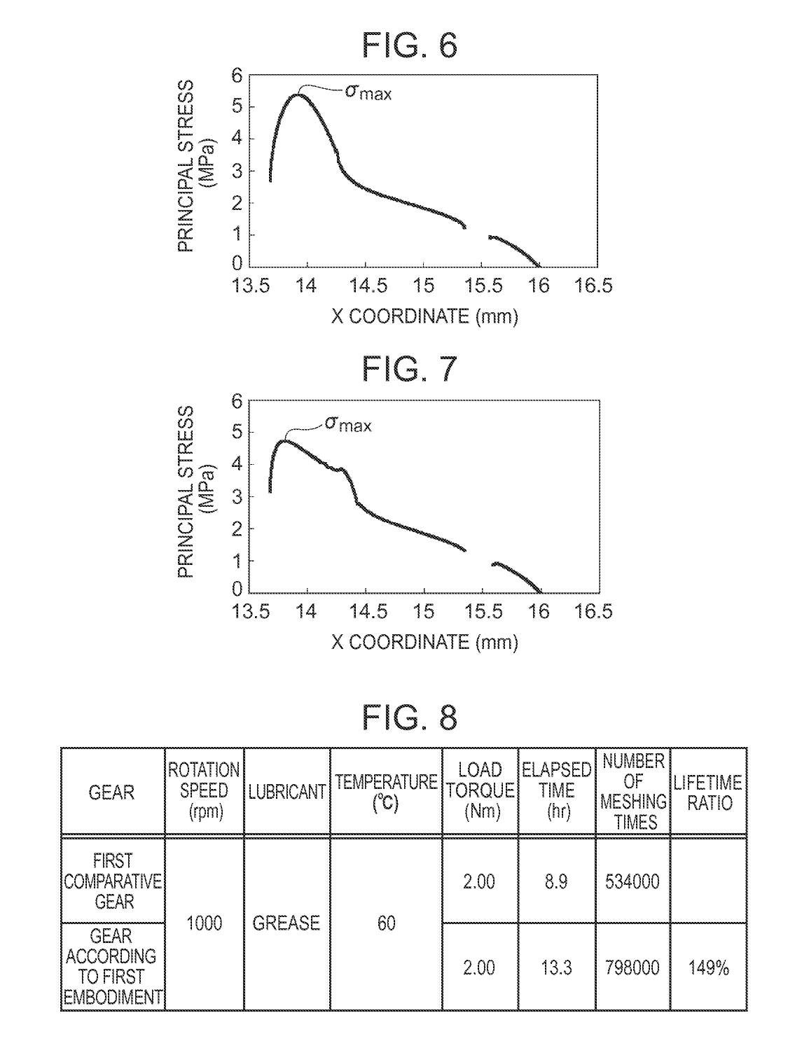

First, the stress distribution of the tooth root stress as the analysis result of the first comparative gear is illustrated in FIG. 6. In FIG. 6, the horizontal axis represents the X coordinate (mm) in the whole depth direction, the right side in the coordinate indicates the tooth top side, and the left side indicates the tooth bottom side. The origin of the horizontal axis is the center of the gear (the center of the shaft hole 4). The vertical axis represents the amount of a principal stress (MPa) generated. In the first comparative gear, as illustrated in FIG. 6, the principal stress gradually increases from the tooth top side to the tooth bottom side, the principal stress suddenly increases at about 14.3 mm of the X coordinate, and the maximum principal stress amax reaches 5.39 MPa.

Next, the stress distribution of the tooth root stress as the analysis result of the gear according to the first embodiment is illustrated in FIG. 7. In FIG. 7, the horizontal axis and the vertical axis represent the X coordinate (mm) in the whole depth direction and the amount of the principal stress (MPa) generated, respectively, similarly to FIG. 6. In the gear according to the first embodiment, as illustrated in FIG. 7, although the principal stress gradually increases from the tooth top side to the tooth bottom side, the maximum principal stress σ max is 4.7 MPa, which is less by about 13% than that of the first comparative gear. In the stress variation from the tooth top to the tooth bottom, the sudden stress variation in the first comparative gear is reduced.

As can be seen from the analysis result of the simulation, by employing the tooth profile of the gear according to the first embodiment, it is possible to further reduce the stress generated on the tooth root side at the time of meshing with the corresponding gear than that of the first comparative gear and thus to increase the strength of the teeth. Accordingly, it is possible to improve long-term durability characteristics of the teeth.

In the gear according to the first embodiment, since the profile on the tooth root side is formed as the curved surface defined by the hyperbolic function, the stress is not likely to be concentrated on the tooth root side in comparison with the conventional gear in which a pointed triangular depressed point is formed on the tooth bottom surface.

The results of a durability test that is performed on the gear according to the first embodiment will be described below in comparison with the durability test results that is performed on a comparative gear.

FIG. 8 is a table illustrating the durability test results of the gear according to the first embodiment and the first comparative gear. In this durability test, a gear, in which the coefficient k was 0.343, set in y=k×cos h(x/k), which is a part of the hyperbolic function for defining the second curved surface d and is called catenary curve, was used as the gear according to the first embodiment illustrated in FIG. 3. The first comparative gear is the same as the gear used in the computer-aided simulating and analyzing (CAE) and is subjected to gear-generation cutting using a rack-type cutter having a blade edge including a round portion defined by an arc, in the tooth profile of the standard gear. The gear according to the first embodiment and the first comparative gear as samples had specifications of spur gear, in which a module (m) was 1, a pressure angle was 20°, the number of teeth was 30 teeth, and a tooth width was 5 mm. The material thereof was resin (POM), in which a Young's modulus was 2800 MPa, and a Poisson's ratio was about 0.38, for example, “DURACON M90-44” made by POLYPLASTICS Co., Ltd.

In the conditions of the durability test, the rotation speed was 1000 rpm, the lubricant was grease, “MULTEMP TA No. 2” made by KYODO YUSHI CO., LTD., the atmosphere temperature was 60° C., and the load torque was 2.00 Nm. Regarding the test method, the gears according to the first embodiment were made to mesh with each other and to rotate in the same direction, and the first comparative gears were made to mesh with each other and to rotate in the same direction, and the results of the elapsed time (hr) and the number of meshing times until any one of the meshing gears was damaged were compared.

As the durability test results, the first comparative gear was damaged at the time point at which 8.9 hours elapsed after the start of rotation and the number of meshing times reached 534000, as illustrated in FIG. 8. On the other hand, the gear according to the first embodiment was damaged at the time point at which 13.3 hours elapsed after the start of rotation and the number of meshing times reached 798000. According to this test results, it can be seen that the ratio of the lifetime of the gear according to the first embodiment to the lifetime of the first comparative gear is 149%, and the durability characteristics are improved by the increase in strength of the gear according to the first embodiment.

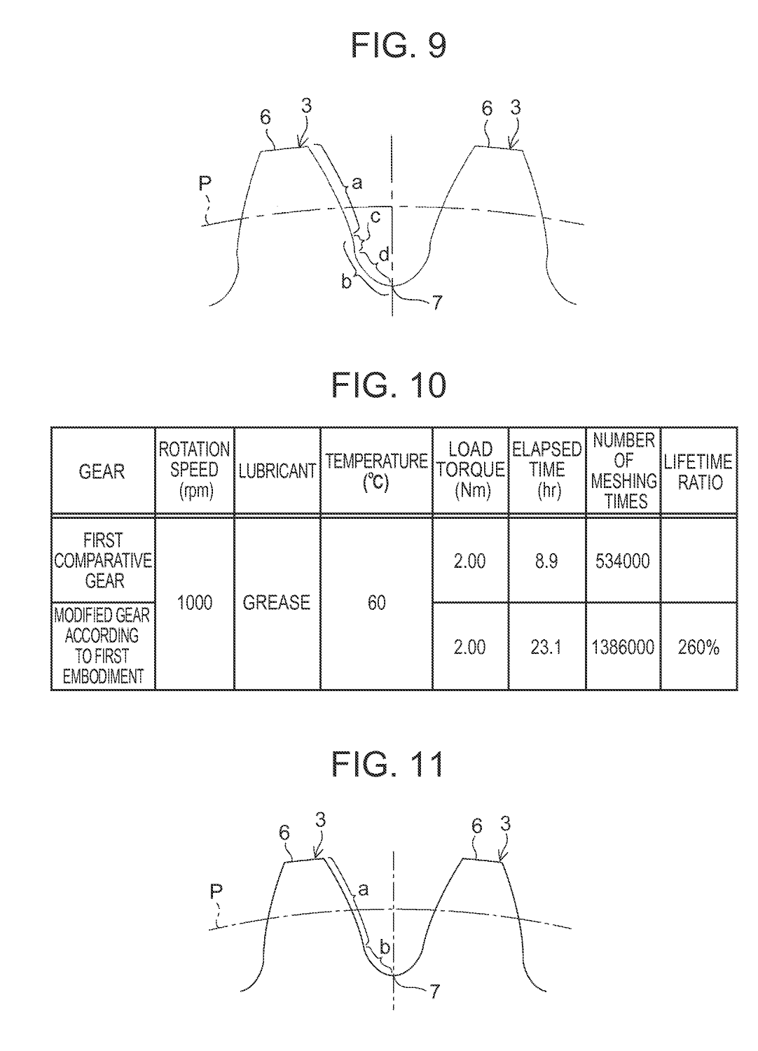

FIG. 9 is an enlarged explanatory view illustrating a tooth profile of a modified gear according to the first embodiment. The tooth surface a, the tooth surface b, the first curved surface c, and the second curved surface d in FIG. 9 have the same meanings as illustrated in FIG. 3. In FIG. 9, the coefficient k in y=k x cos h(x/k), which is a part of the hyperbolic function for defining the second curved surface d and is called catenary curve, was 0.428. In the modified gear according to the first embodiment, the tooth surface b on the tooth root side has a profile closer to a semi-arc shape than the gear according to the first embodiment. The durability test results of the modified gear 1 according to the first embodiment having the determined tooth profile will be described below.

FIG. 10 is a table illustrating the durability test results of the modified gear according to the first embodiment and the first comparative gear. In this durability test, the modified gear according to the first embodiment illustrated in FIG. 9 and the first comparative gear were compared. In this case, the specifications, materials, durability test conditions, test method, and the like of the modified gear according to the first embodiment and the first comparative gear as samples were the same as in the durability test illustrated in FIG. 8.

As the durability test results, the first comparative gear was damaged at the time point at which 8.9 hours elapsed after the start of rotation and the number of meshing times reached 534000, as illustrated in FIG. 10. On the other hand, the modified gear according to the first embodiment was damaged at the time point at which 23.1 hours elapsed after the start of rotation and the number of meshing times reached 1386000. According to the test results, it can be seen that the ratio of the lifetime of the modified gear according to the first embodiment to the lifetime of the first comparative gear is 260%, and the durability characteristics are improved by the increase in strength of the modified gear according to the first embodiment.

FIG. 11 is an enlarged explanatory view illustrating a profile of a tooth 3 of a gear 1 according to a second embodiment. In FIG. 11, in a side surface of the tooth 3, a tooth surface a is provided, and a tooth surface b is provided on a tooth root side with respect to the tooth surface a. The tooth 3 of the gear 1 according to the second embodiment is provided with an advantageous profile on the tooth root side with respect to the tooth surface a, and thus, as illustrated in FIG. 10, a form of the tooth surface b on the tooth root side of each tooth 3 is identical to a form shaped by a gear-generation cutting using a rack-type cutter having a blade edge including a round portion with a curve defined by a hyperbolic function. In particular, a portion thereof that is connected to a tooth bottom surface 7 (see FIG. 2) is formed as a concave curved surface.

The concave curved surface (b) is smoothly connected to the tooth surface a having an involute curve and has a profile expressed by a curve that is convex in the inverse direction of the involute curve of the tooth surface a. The gear 1 having such a tooth root side profile may be a metal gear produced by cutting a metal material of metal materials, or may be a resin gear produced by injection-molding a resin or resins.

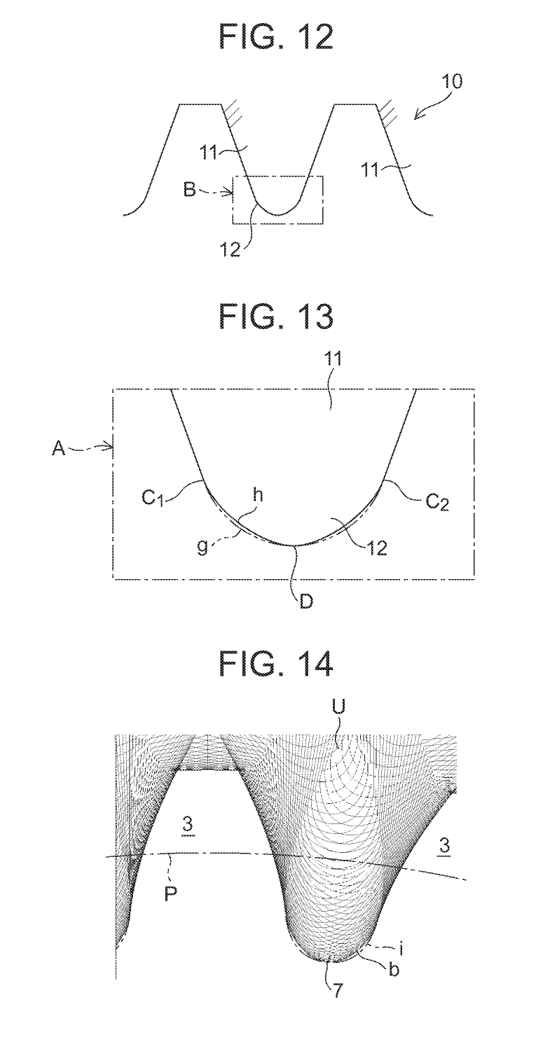

To produce the gear 1 having the tooth profile illustrated in FIG. 11, a tooth root side of each tooth 3 may be formed to the form identical to the form shaped by the gear-generation cutting using the rack-type cutter having the blade edge including the round portion with the curve defined by the hyperbolic function. A rack-type cutter 10 used in this case has a blade edge 12 of a blade 11 thereof, the blade edge 12 including a round portion with a curve defined by a hyperbolic function, as illustrated in FIG. 12. The hyperbolic function is expressed by y=cos h(x), called a hyperbolic cosine function. Alternatively, the hyperbolic function may be a part of a hyperbolic function, and may be expressed by y=k×cos h(x/k) (where k is a coefficient), called a catenary curve.

The detailed profile of B-portion of FIG. 12 is illustrated in FIG. 13. In FIG. 13, in general, when a gear having a great tooth-root strength is produced by the gear-generation cutting in general gear designs, the blade 11 of the rack-type cutter 10 has a portion of the blade edge 12 formed as an arc. That is, a portion defined by points C₁, D, and C₂ of the blade edge 12 is formed as an arc g having a predetermined radius (conventional example). On the contrary, the blade 11 of the rack-type cutter 10 used to produce the gear 1 according to the second embodiment has a portion defined by points C₁, D, and C₂ of the blade edge 12 illustrated in FIG. 13 replaced with a round portion represented by a curve h defined by the hyperbolic function. In this case, the curve h defined by the hyperbolic function is located inside the arc g of the conventional example, and accordingly, the blade edge 12 becomes slightly narrow. The gear 1 which is subjected to the gear-generation cutting using the rack-type cutter 10 having such blade edge 12 has a greater tooth thickness on the tooth root side than that of the gear subjected to the gear-generation cutting using the conventional rack-type cutter having the blade edge 12 formed as the arc g. In FIG. 13, although the portion defined by the points C₁, D, and C₂ of the cutting edge 12 is replaced with the curve h defined by the hyperbolic function, the positions of the left-and-right curve starting points (or connection points) C₁ and C₂ may be set at any positions within a range that does not interfere with a locus of motion of the meshing teeth of the corresponding gear.

FIG. 14 is an explanatory view illustrating a locus of motion of the blade edge 12 at the time of performing the gear-generation cutting using the rack-type cutter 10 illustrated in FIG. 12. In this case, there is illustrated a configuration in that the gear 1 is produced, in which the gear 1 is made of metal and in which the tooth root side of each tooth 3 is subjected to the gear-generation cutting using the rack-type cutter 10 having the blade edge 12 including the round portion with the curve defined by the hyperbolic function. The locus of motion of the cutting edge 12 when the gear-generation cutting is carried out by bringing the blade 11 of the rack-type cutter 10 into contact with the material of the gear 1 can be obtained as a curve U illustrated in FIG. 14. The vertex of the curve U comes into contact with the tooth bottom surface 7 in the tooth space between the teeth 3 and 3 of a standard gear. In this case, since the concave curved surface (b) illustrated in FIG. 11 is located inside the tooth surface on the tooth root side of the standard gear indicated by a chain line i in FIG. 14, the tooth thickness on the tooth root side can be greater than that in the conventional example. The pointed triangular depressed point as described in Patent Document 1 is not formed on the tooth bottom surface 7 of the gear. In FIG. 14, the profile of the concave curved surface (b) is formed as the curve which is in contact with the tooth bottom surface 7 of the standard gear, but the second embodiment is not limited thereto, and the curve may be set to any position that does not interfere with the locus of motion of the teeth of the corresponding gear. For example, when the curve of the concave curved surface is set to a position above the tooth bottom surface 7 of the standard gear, it is possible to further increase the strength of the teeth.

The above description is given for the case in which the metal gear is produced, but the second embodiment is not limited thereto. The gear 1 may be made of resin and the resin gear may be produced by an injection-molding by using a gear piece (mold) formed based on a gear in which a tooth root side of each tooth 3 is subjected to the gear-generation cutting using the rack-type cutter 10 having the blade edge 12 including the round portion with the curve defined by the hyperbolic function. In producing the gear piece in this case, the metal gear that is obtained by the gear-generation cutting using the rack-type cutter 10 may be used as an electrode, to produce the gear piece by an electric discharging machining. Alternatively, the gear piece may be produced using a known method other than the electric discharge machining.

Regarding the gear 1 according to the second embodiment having the tooth profile set as described above, results obtained by a computer-aided simulating and analyzing (CAE) the stress generated on the tooth root side at the time of meshing will be described below. In this case, a gear with the tooth profile of the standard gear, which is formed by gear-generation cutting using a rack having a blade edge including a round portion defined by an arc is used as a gear to be compared (hereinafter, referred to as “second comparative gear”).

First, calculation models and analysis conditions used for calculating a tooth root stress in the simulation will be described below. The gear according to the second embodiment and the second comparative gear, used in this analysis, were spur gears, in which a module (m) was 1, and the number of teeth was 30. The material thereof was resin (POM), in which a Young's modulus was 2800 MPa, and a Poisson's ratio was about 0.38. The meshing corresponding gear had the same specifications as the gear according to the second embodiment and the second comparative gear. Regarding a load condition, a load of 10 N was applied to the worst loading point position in a direction of a normal line of the tooth surface. A shell mesh model in which only one tooth was extracted was used as the analysis model. “Solid Works” was used as the calculation software for calculating the tooth root stress.

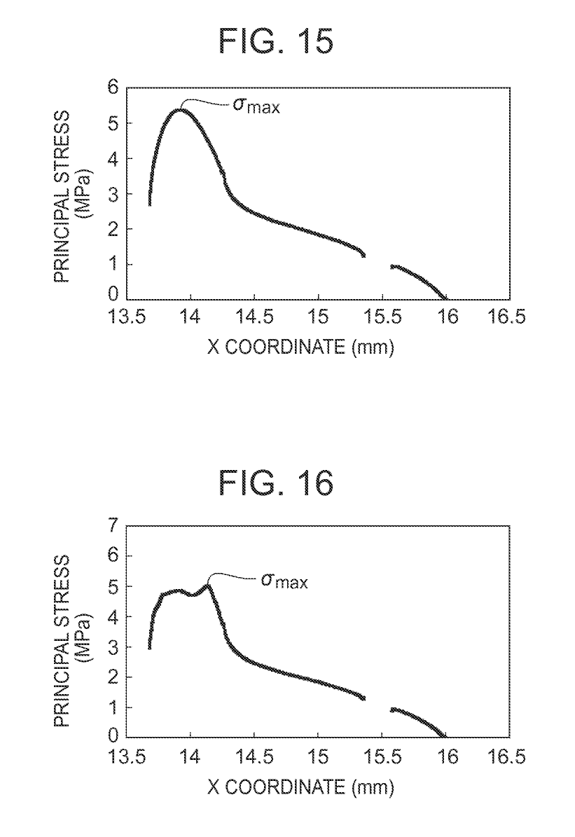

First, the stress distribution of the tooth root stress as the analysis result of the second comparative gear is illustrated in FIG. 15. In FIG. 15, the horizontal axis represents the X coordinate (mm) in the whole depth direction, the right side in the coordinate indicates the tooth top side, and the left side indicates the tooth bottom side. The origin of the horizontal axis is the center of the gear (the center of the shaft hole 4). The vertical axis represents the amount of a principal stress (MPa) generated. In the second comparative gear, as illustrated in FIG. 15, the principal stress gradually increases from the tooth top side to the tooth bottom side, the principal stress suddenly increases at about 14.3 mm of the X coordinate, and the maximum principal stress σmax reaches 5.39 MPa.

Next, the stress distribution of the tooth root stress as the analysis result of the gear according to the second embodiment is illustrated in FIG. 16. In FIG. 16, the horizontal axis and the vertical axis represent the X coordinate (mm) in the whole depth direction and the amount of the principal stress (MPa) generated, respectively, similarly to FIG. 15. In the gear according to the second embodiment, as illustrated in FIG. 16, although the principal stress also gradually increases from the tooth top side to the tooth bottom side and the principal stress increases at about 14.3 mm of the X coordinate, the maximum principal stress σmax is 5.05 MPa. In this case, the position at which the principal stress suddenly increases is substantially the same as that of the second comparative gar. The state of the sudden increase is also substantially the same as that of the second comparative gear. However, in the gear according to the second embodiment, the maximum principal stress σmax is less than that of the second comparative gear (decrease of about 6%). In the stress distribution on the tooth root side, there is indicated a convex distribution having one peak (maximum value) in the second comparative gear, and there is indicated a pattern in which the stress is widely distributed (planarized) in the gear according to the second embodiment. Accordingly, it is thought that the maximum principal stress is decreased thereby.

As can be seen from the analysis result of the simulation, by employing the tooth profile of the gear according to the second embodiment, it is possible to further reduce the stress generated on the tooth root side at the time of meshing with the corresponding gear than that of the second comparative gear and thus to increase the strength of the teeth. Accordingly, it is possible to improve long-term durability characteristics of the teeth.

In the gear according to the second embodiment, in the form of the tooth root side of each tooth, the stress can be not likely to be concentrated on the tooth root side in comparison with the conventional gear in which a pointed triangular depressed point is formed on the tooth bottom surface.

In the aforementioned embodiments, the examples of the invention are applied to the standard gear, but the invention is not limited thereto, and may be applied to, for example, a profile-shifted gear.

The gear according to the embodiments of the present invention is not limited to the spur gear, but can be widely applied to tooth profiles of other types of gears, such as a helical gear, a herringbone gear, a bevel gear, a face gear, a worm gear, a hypoid gear, and the like. The gear according to the embodiments of the present invention is not limited to a gear made of resin, but can be applied to a gear made of metal (for example, alloy steel for machine construction, carbon steel, stainless steel, brass, and phosphor bronze).

1. A gear comprising a plurality of teeth to mesh with teeth of a corresponding gear to thereby transmit a rotational motion,
wherein a form of a tooth root side of each tooth comprises: a first curved surface that is smoothly connected to a tooth surface having an involute curve and has a profile expressed by a curve that is convex in an inverse direction of the involute curve of the tooth surface; and a second curved surface that is smoothly connected to the first curved surface and has a profile defined by a hyperbolic function having a curve being convex in the same direction as the first curved surface.

2. The gear according to claim 1, wherein the profile of the second curved surface, when viewed in a tooth perpendicular section thereof, is a curve with a curvature radius that does not interfere with a locus of motion of the meshing teeth of the corresponding gear.

3. The gear according to claim 1 or 2, wherein the profile of the first curved surface, when viewed in a tooth perpendicular section thereof, is a spline curve that follows along an arc with a curvature radius that does not interfere with a locus of motion of the meshing teeth of the corresponding gear or along an interference region of the locus of motion.

4. A gear comprising a plurality of teeth to mesh with teeth of a corresponding gear to thereby transmit a rotational motion,
wherein a form of a tooth root side of each tooth is identical to a form shaped by a gear-generation cutting using a rack-type cutter having a blade edge including a round portion with a curve defined by a hyperbolic function.

5. A method of producing a gear comprising a plurality of teeth to mesh with teeth of a corresponding gear to thereby transmit a rotational motion,
the method comprising the step of: forming a tooth root side of each tooth to a form identical to a form shaped by gear-generation cutting using a rack-type cutter having a blade edge including a round portion with a curve defined by a hyperbolic function.

6. The method of producing a gear according to claim 5, wherein the gear is made of metal, and wherein the tooth root side of each tooth is subjected to the gear-generation cutting using the rack-type cutter having the blade edge including the round portion of the curve defined by the hyperbolic function.

7. The method of producing a gear according to claim 5, wherein the gear is made of resin, and wherein the gear is injection-molded by using a gear piece formed based on a gear in which a tooth root side of each tooth is subjected to the gear-generation cutting using the rack-type cutter having the blade edge including the round portion of the curve defined by the hyperbolic function.
